(19) United States
(12) Patent Application Publication
(10) Pub. No.: US 2016/0292090 A1
(43) Pub. Date: Oct. 6, 2016

(54) DATA PROCESSING SYSTEM CAPABLE OF CONTROLLING PERIPHERAL DEVICES USING GROUP IDENTIFICATION INFORMATION AND CONTROL METHOD THEREOF

(71) Applicant: SK hynix Inc., Icheon-si (KR)

(72) Inventors: Yong Ju KIM, Icheon-si Gyeonggi-do (KR); Sang Gu JO, Icheon-si Gyeonggi-do (KR); Jae Sun LEE, Icheon-si Gyeonggi-do (KR)

(21) Appl. No.: 14/725,003

(22) Filed: May 29, 2015

(30) Foreign Application Priority Data
Apr. 6, 2015 (KR) 10-2015-0048622

(51) Int. Cl. G06F 13/10; G06F 13/12

(52) U.S. Cl. CPC G06F 13/102; G06F 13/12

(57) ABSTRACT

A data processing system includes a plurality of peripheral devices in which device identification information and group identification information are stored, and a controller. The peripheral devices of the same species device group have the same group identification information, and peripheral devices from different peripheral device groups have different group identification information. The controller controls peripheral devices of the same species device group to perform the same operation.

### CROSS-REFERENCES TO RELATED APPLICATION

This application claims priority under 35 U.S.C. 119(a) to Korean application number 10-2015-0048622 filed on Apr. 6, 2015, in the Korean intellectual property Office, which is incorporated by reference in its entirety.

### BACKGROUND

1. Technical Field

The inventive concept relates to an electronic system, and more particularly to a data processing system and a control method thereof.

2. Related Art

Electronic systems such as computer systems may have controllers such as central processing units (“CPU”) therein to control a plurality of peripheral devices. The CPU may, among other things, receive data and transform the received data into another so as to give the desired system response and control the plurality of improvement of efficiency.

The performance of electronic systems may be determined depending on the amount of work performed by the controller with respect to the plurality of peripheral devices. Therefore, the efficiency of the controller in controlling the improvement of efficiency is important to improve the system performance.

### SUMMARY

Various embodiments are provided with respect to a data processing system capable of efficiently controlling a plurality of peripheral devices and a control method thereof.

According to an embodiment, a data processing system may include a plurality of peripheral devices in which device-specific information and group-specific information are stored; and a controller coupled to the plurality of devices through a signal line. The group-specific information may have the same value for peripheral devices included in the same group, and have different values for peripheral devices included in different groups. The controller may control peripheral devices included in a desired group among the plurality of peripheral devices to perform the same command using the group-specific information.

According to an embodiment, a data processing system may include a plurality of peripheral devices in which different pieces of device-specific information are stored, and pieces of group-specific information having different values for groups and having the same value for the same group are stored; and a controller commonly coupled to the plurality of peripheral devices through a system management bus, and configured to control peripheral devices included in a desired group among the plurality of peripheral devices to perform the same command using the group-specific information.

According to an embodiment, a control method may include transmitting a data packet including device identification information and a command to a plurality of devices from a controller; and performing the command in the plurality of peripheral devices by comparing device-specific information and group-specific information previously stored with the device identification information.

The group-specific information may have the same value for peripheral devices included in the same group among the plurality of peripheral devices and have different values for peripheral devices included in different groups among the plurality of peripheral devices.

The performing of the command may include simultaneously performing the command in peripheral devices in which the group-specific information having the same value as the device identification information is stored among the plurality of peripheral devices.

These and other features, aspects, and embodiments are described below in the section entitled “DETAILED DESCRIPTION”.

### BRIEF DESCRIPTION OF THE DRAWINGS

The above and other aspects, features and other advantages of the subject matter of the present disclosure will be more clearly understood from the following detailed description taken in conjunction with the accompanying drawings, in which:

FIG. 1 is a configuration diagram illustrating a data processing system according to an embodiment of the inventive concept;

FIG. 2 is a configuration diagram illustrating a peripheral device of FIG. 1; and

FIG. 3 is a flowchart illustrating a control method of a data processing system according to an embodiment of the inventive concept.

### DETAILED DESCRIPTION

Hereinafter, exemplary embodiments will be described in greater detail with reference to the accompanying drawings. Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing. In the drawings, lengths and sizes of layers and regions may be exaggerated for clarity. Like reference numerals in the drawings denote like elements. It is also understood that when a layer is referred to as being “on” another layer or substrate, it can be directly on the other or substrate, or intervening layers may also be present.

The inventive concept is described herein with reference to cross-section and/or plan illustrations that are schematic illustrations of idealized embodiments of the inventive concept. However, embodiments of the inventive concept should not be limited construed as limited to the inventive concept. Although a few embodiments of the inventive concept will be shown and described, it will be appreciated by those of ordinary skill in the art that changes may be made in these exemplary embodiments without departing from the principles and spirit of the inventive concept.

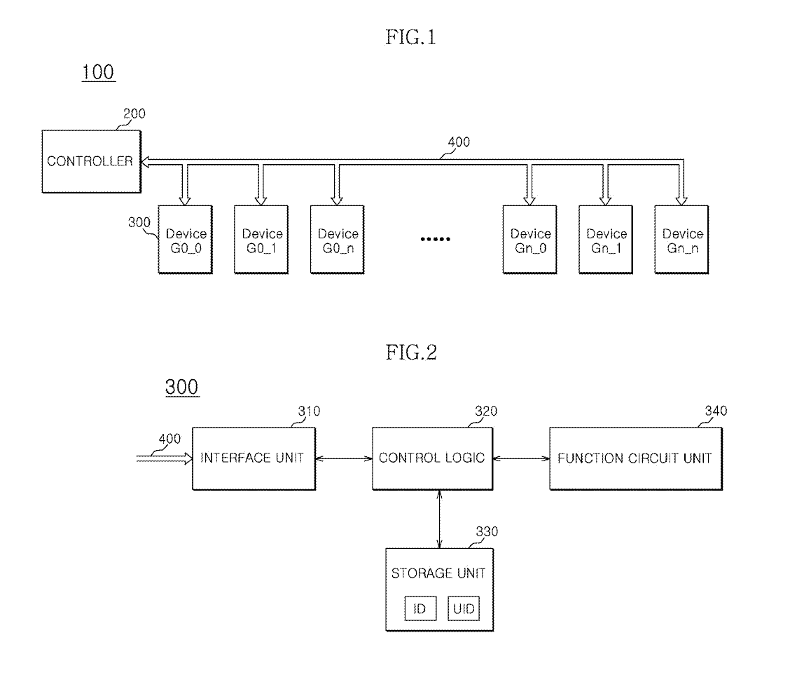

As illustrated in FIG. 1, a data processing system 100 according to an embodiment of the inventive concept may include a controller 200, a plurality of peripheral devices 300, and a signal line 400.

The controller 200 may include a central processing unit (“CPU”), a graphic processing unit (“GPU”), or the like.

The controller 200 may be a memory controller, which has the logic necessary to read and write to semiconductor memory chips.

Each of the plurality of peripheral devices 300 may include one or more semiconductor memory chips.

The plurality of peripheral devices 300 may be divided into a plurality of peripheral device group.

For example, some of the plurality of peripheral devices 300 may be the same type of devise, and the peripheral devices of the same type may form a peripheral device group.

In an embodiment, the plurality of peripheral devices 300 may be divided into a plurality of peripheral device group, e.g., a first peripheral device group G0_0, G0_1, . . . , G0_n and a nth peripheral device group Gn_0, G0_1, . . . , Gn_n.

The first peripheral device group G0_0, G0_1, . . . , G0_n may be a memory module including a plurality of memory chips such as a dual in-line memory module (“DIMM”).

Device identification information ID and group identification information UID may be stored in each of the plurality of peripheral devices 300.

The device identification information ID of a peripheral device may be used to identify the peripheral device among the plurality of peripheral devices 300.

The group identification information UID of a peripheral device group may be used to identify the peripheral device group among the plurality of peripheral device groups.

In an embodiment, different types of peripheral devices may have the same group identification information UID if their tasks are required to be done at the same time, if they are supposed to respond to the same command, or if the same group identification information UID has been set to the different types of peripheral devices for a particular purpose.

The controller 200 may control the plurality of peripheral devices 300 using the device identification information ID.

The controller 200 may control the plurality of peripheral devices 300 such that the plurality of peripheral devices 300 having the same device identification information ID simultaneously received the same command and carry out the same task.

The controller 200 may transmit a data packet, which includes identification information and a command therein, to the plurality of peripheral devices 300 through the signal line 400.

The identification information may include the device identification information ID and/or the group identification information UID.

The controller 200 may store the same group identification information UID in some of the plurality of peripheral devices 300 so that they act as a peripheral device group.

The plurality of peripheral devices 300 may be coupled to the controller 200 through common signal lines such as the signal line 400.

The signal line 400 may include a system management bus (“SMBUS”).

The SMBUS may be served as an input/output (“I/O”) interface between a memory module and the controller 200 according to a communication protocol.

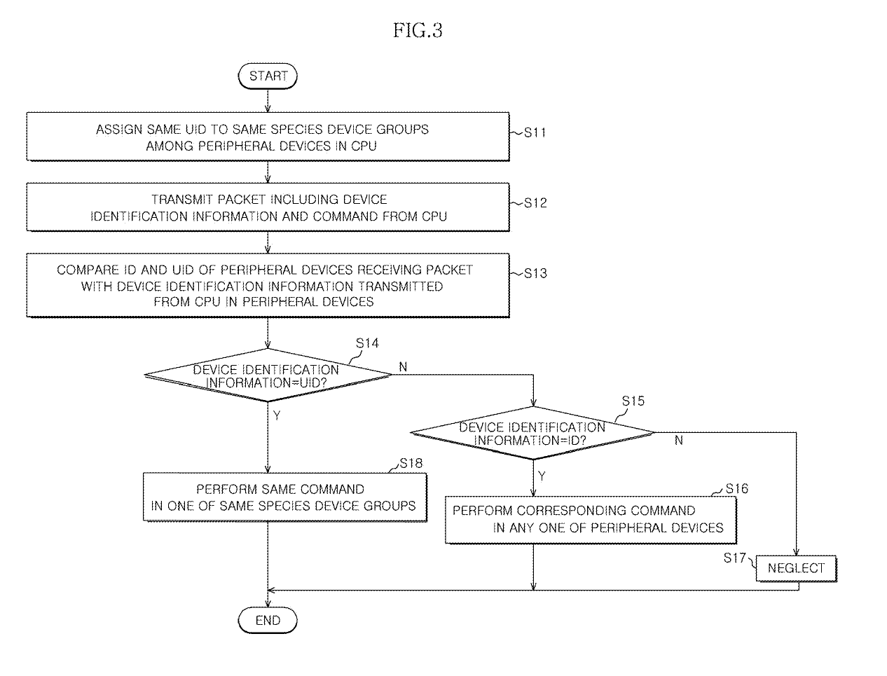

As illustrated in FIG. 2, each of the peripheral devices 300 may include an interface unit 310, a control logic 320, and a storage unit 330.

The peripheral device 300 may further include a function circuit unit 340.

The function circuit unit 340 may include logic circuits performing a particular function allocated to the peripheral device 300.

The interface unit 310 may be coupled to the signal line 400, and perform a signal I/O interfacing operation between the controller 200 and internal circuit units of the peripheral device 300.

The storage unit 330 may store the device identification information ID and the group identification information UID.

The storage unit 330 may include a register to store the device identification information ID and the group identification information UID.

The storage unit 330 may further include a memory block to store data or control programs such as firmware.

The control logic 320 may perform operations corresponding to the command defined in the data packet. In an embodiment, whether the peripheral device 300 is targeted peripheral device may be determined by comparing the device identification information ID and the group identification information UID stored in the storage unit 330 with the identification information of the data packet transmitted from the controller 200.

In an embodiment, the control logic 320 may perform operations corresponding to the command defined in the data packet even when the identification information of the data packet is coincident with any one of the device identification information ID and the group identification information UID stored in the storage unit 330.

The control logic 320 may store the group identification information UID in the storage unit 330 according to a command of the controller 200.

Hereinafter, a control method of the data processing system 100 having the above-described configuration according to an embodiment of the inventive concept will be described with reference to FIGS. 1 to 3.

Each peripheral device 300 may have its own device identification information ID having different values.

The same group identification information UID may be assigned to each of the same species device groups (e.g., the first peripheral device group G0_0, G0_1, . . . , G0_n and the nth peripheral device group Gn_0, G0_1, . . . , Gn_n) among the plurality of peripheral devices (S11).

For example, the controller 200 may assign the group identification information UID in each of same species device groups in such a manner that a value “a” is assigned to the peripheral devices included in the same species device group Device G0_0 to Device G0_n, a value “b” is assigned to the peripheral devices included in the same species device group Device G1_0 to Device G1_n, and a value “x” is assigned to the peripheral devices included in the same species device group Device Gn_0 to Device Gn_n

The above-described step S11 may be omitted when group identification information UID has already been stored in each peripheral device.

The controller 200 transmits the data packet, which include the identification information and a command therein, to the plurality of devices 300 through the signal line 400 (S12).

The identification information of the data packet may include one or both of the device identification information ID and the group identification information UID.

The command of the data packet may include commands which are supposed to be performed in common by the peripheral devices that have the same group identification information UID. For example, the command may include a firmware update command for updating firmware of peripheral devices.

The command of the data packet may be a command for simultaneously activating specific regions of the peripheral devices that have the same group identification information UID.

Each peripheral device 300 which receives the data packet compares the device identification information ID and the group identification information UID thereof with the identification information transmitted from the controller 200 (S13).

Each peripheral device 300 may determine whether or not the identification information transmitted from the controller 200 is coincident with the group identification information UID (S14).

When the identification information transmitted from the controller 200 is not coincident with the group identification information UID, each peripheral device 300 may determine whether or not the identification information transmitted from the controller 200 is coincident with the device identification information ID (S15).

When the identification information transmitted from the controller 200 is coincident with the device identification information ID, the peripheral device that has the device identification information ID identical to the identification information transmitted from the controller 200 performs predetermined operations corresponding to the command of the data packet (S16).

When the identification information transmitted from the controller 200 is not coincident with the device identification information ID, the peripheral device 300 neglects the command of the data packet, and maintains a current operation state (S17).

When the identification information transmitted from the controller 200 is coincident with the group identification information UID, peripheral devices, which are in the same species device group having the group identification information UID identical to the group identification information, may perform predetermined operations corresponding to the command of the data packet (S18).

In an embodiment, the group identification information UID is assigned in peripheral devices in the same species device group in such a manner that the same group identification code is assigned to each peripheral device of the first peripheral device group G0_0, G0_1, . . . , G0_n and that group identification code is different from a group identification code that is assigned to the nth same species device group Gn_0, G0_1, . . . , Gn_n.

For example, when the controller 200 transmits the data packet, which includes a firmware update command and the identification information corresponding to the nth same species device group Gn_0, G0_1, . . . , Gn_n, the peripheral devices of the nth same species device group Gn_0, G0_1, . . . , Gn_n may simultaneously perform firmware update.

When the controller 200 transmits the data packet, which includes a specific memory region activation command and the identification information corresponding to the first same species device group G0_0, G0_1, . . . , G0_n, the peripheral devices of the first same species device group G0_0, G0_1, . . . , G0_n may simultaneously activate corresponding memory regions.

In an embodiment, the plurality of peripheral devices may perform the same operation at the same time by receiving command and identification information.

In an embodiment, the peripheral device group may be set on the basis of types of peripheral device. In an embodiment, different types of peripheral devices may be set as the same species device group. If different types of peripheral devices are required to response a particular command, different types of peripheral devices may be grouped as the same species device groups.

The above embodiment of the present invention is illustrative and not limitative. Various alternatives and equivalents are possible. The invention is not limited by the embodiment described herein. Nor is the invention limited to any specific type of semiconductor device. Other additions, subtractions, or modifications are obvious in view of the present disclosure and are intended to fall within the scope of the appended claims.

1. A data processing system comprising:
a plurality of peripheral devices in which device identification information and group identification information are stored; and
a controller coupled to the plurality of devices through a signal line,
wherein the device identification information of the plurality of peripheral devices are different from each other, peripheral devices of the same species device group have the same group identification information, peripheral devices from different peripheral device groups have different group identification information, and
the controller simultaneously selects peripheral devices of the same species device group to perform the same operation using the group identification information.

2. The data processing system of claim 1, wherein the signal line includes a system management bus.

3. The data processing system of claim 1, wherein the peripheral devices of the same species device group are the same type of devices.

4. The data processing system of claim 1, wherein each peripheral device includes:
a storage unit configured to store the device identification information and the group identification information; and
a control logic configured to perform operations corresponding to commands transmitted from the controller if one or both of the device identification information and the group identification information are identical to identification information transmitted from the controller.

5. The data processing system of claim 4, wherein the storage unit includes:
a register configured to store the device identification information and the group identification information; and
a memory block configured to store data or control programs.

6. The data processing system of claim 4, wherein the controller provides a data packet having identification information and command, and the control logic performs operations corresponding to the command so long as the identification information of the data packet is coincident with any one of the device identification information and the group identification information.

7. The data processing system of claim 4, wherein each peripheral device further includes:
a logic circuit configured to perform a particular function allocated to the peripheral device; and
an interface unit coupled to the signal line to perform a signal input/output interfacing operation between the controller and the inside of the peripheral device.

8. The data processing system of claim 1, wherein the controller includes a central processing unit or a graphic processing unit.

9. A data processing system comprising:
a plurality of peripheral devices configured to be grouped into a plurality of peripheral device groups such that peripheral devices in the same species device group have the same device identification information; and
a controller coupled to the plurality of peripheral devices through a system management bus to simultaneously select peripheral devices so that peripheral devices of the same species device group perform the same operation using the group identification information,
wherein a device identification information stored in the plurality of peripheral devices are different from each other.

10. The data processing system of claim 9, wherein peripheral devices of the same species device group are the same type of semiconductor memory chips.

11. The data processing system of claim 9, wherein the controller includes a central processing unit or a graphic processing unit.

12. The data processing system of claim 9, wherein each of the plurality of peripheral devices includes:
a storage unit configured to store the device identification information and the group identification information; and
a control logic configured to perform operations corresponding to commands transmitted from the controller if one or both of the device identification information and the group identification information are identical to identification information transmitted from the controller.

13. The data processing system of claim 12, wherein the controller provides a data packet having identification information and command, and the control logic performs operations corresponding to the command so long as the identification information of the data packet is coincident with any one of the device identification information and the group identification information.

14. The data processing system of claim 12, wherein each peripheral device further includes:
a logic circuit configured to perform a particular function allocated to the peripheral device; and
an interface unit coupled to the system management bus to perform a signal input/output interfacing operation between the controller and the inside of the peripheral device.

15. A control method of a data processing system, the control method comprising:
transmitting a data packet including identification information and a command to a plurality of peripheral devices from a controller; and
performing operations corresponding to the command in the plurality of peripheral devices
if one or both device identification information and group identification information stored in the plurality of peripheral devices matches the identification information of data packet.

16. The control method of claim 15, further comprising assigning the group identification information to the plurality of peripheral devices.

17. The control method of claim 15, wherein the device identification information of the plurality of peripheral devices are different from each other, peripheral devices of the same species device group have the same group identification information, and peripheral devices from different peripheral device groups have different group identification information.

18. The control method of claim 15, wherein performing the operations corresponding to the command includes simultaneously performing the operations corresponding to the command in peripheral devices having the group identification information identical to the identification information of data packet.

19. The control method of claim 15, wherein performing the operations corresponding to the command includes performing the operations corresponding to the command in any one of peripheral devices having the group identification information identical to the identification information of data packet.

20. The control method of claim 15, wherein the command includes a firmware update command.
